(19) United States
(12) Patent Application Publication
(10) Pub. No.: US 2004/0059712 A1
(43) Pub. Date: Mar. 25, 2004

(54) Serving advertisements using information associated with e-mail

(76) Inventors: Jeffrey A. Dean, Menlo Park, CA (US); Georges R. Harik, Mountain View, CA (US); Paul Buchheit, Mountain View, CA (US)

Correspondence Address: STRAUB & POKOTYLO, 620 TINTON AVENUE, BLDG. B, 2ND FLOOR, TINTON FALLS, NJ, 07724, US

(21) Appl. No.: 10/452,830

(22) Filed: Jun. 2, 2003

Related U.S. Application Data
(63) Continuation-in-part of application No. 10/314,427, filed on Dec. 6, 2002.
(63) Continuation-in-part of application No. 10/375,900, filed on Feb. 26, 2003.
(60) Provisional application No. 60/413,536, filed on Sep. 24, 2002.

(51) Int. Cl. G06F 7/00

(52) U.S. Cl. 707/1

(57) ABSTRACT

Advertisers are permitted to put targeted ads on e-mails. The present invention may do so by (i) obtaining information of an e-mail that includes available spots for ads, (ii) determining one or more ads relevant to the e-mail information, and/or (iii) providing the one or more ads for rendering in association with the e-mail.

### § 0. RELATED APPLICATION

This application is a continuation-in-part of (i) U.S. patent application Ser. No. 10/314,427, entitled “METHODS AND APPARATUS FOR SERVING RELEVANT ADVERTISEMENTS”, filed on Dec. 6, 2002 and listing Jeffrey A. Dean, Georges R. Harik and Paul Bucheit as inventors; and (ii) U.S. patent application Ser. No. 10/375,900, entitled “SERVING ADVERTISEMENTS BASED ON CONTENT”, filed on Feb. 26, 2003 and listing Darrell Anderson, Paul Bucheit, Alex Carobus, Claire Cui, Jeffrey A. Dean, Georges R. Harik, Deepak Jindal and Narayanan Shivakumar as inventors, each of which applications claims benefit to the filing date of U.S. Provisional Application Serial No. 60/413,536, entitled “METHODS AND APPARATUS FOR SERVING RELEVANT ADVERTISEMENTS”, filed on Sep. 24, 2002 and listing Jeffrey A. Dean, Georges R. Harik and Paul Bucheit as inventors. Benefit to these applications is claimed, under 35 U.S.C. § 119(e)(1) and 35 U.S.C. § 120. The provisional application and utility applications are expressly incorporated herein by reference.

### § 1. BACKGROUND OF THE INVENTION

§ 1.1 Field of the Invention

The present invention concerns advertising. In particular, the present invention concerns expanding the opportunities for advertisers to target their ads.

§ 1.2 Related Art

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Advertisers have developed several strategies in an attempt to maximize the value of such advertising. In one strategy, advertisers use popular presences or means for providing interactive media or services (referred to as “Web sites” in the specification without loss of generality) as conduits to reach a large audience. Using this first approach, an advertiser may place ads on the home page of the New York Times Web site, or the USA Today Web site, for example. In another strategy, an advertiser may attempt to target its ads to more narrow niche audiences, thereby increasing the likelihood of a positive response by the audience. For example, an agency promoting tourism in the Costa Rican rainforest might place ads on the ecotourism-travel subdirectory of the Yahoo Web site. An advertiser will normally determine such targeting manually.

Regardless of the strategy, Web site-based ads (also referred to as “Web ads”) are typically presented to their advertising audience in the form of “banner ads”—i.e., a rectangular box that includes graphic components. When a member of the advertising audience (referred to as a “viewer” or “user” in the Specification without loss of generality) selects one of these banner ads by clicking on it, embedded hypertext links typically direct the viewer to the advertiser's Web site. This process, wherein the viewer selects an ad, is commonly referred to as a “click-through” (“Click-through” is intended to cover any user selection.). The ratio of the number of click-throughs to the number of impressions of the ad (i.e., the number of times an ad is displayed) is commonly referred to as the “click-through rate” of the ad. A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's web page, and consummates a purchase there before leaving that web page. Alternatively, a conversion may be defined as a user being shown an ad, and making a purchase on the advertiser's web page within a predetermined time (e.g., seven days). Many other definitions of what constitutes a conversion are possible. The ratio of the number of conversions to the number of impressions of the ad (i.e., the number of times an ad is displayed) is commonly referred to as the conversion rate. If a conversion is defined to be able to occur within a predetermined time since the serving of an ad, one possible definition of the conversion rate might only consider ads that have been served more than the predetermined time in the past.

Despite the initial promise of Web site-based advertisement, there remain several problems with existing approaches. Although advertisers are able to reach a large audience, they are frequently dissatisfied with the return on their advertisement investment.

Similarly, the hosts of Web sites on which the ads are presented (referred to as “Web site hosts” or “ad consumers”) have the challenge of maximizing ad revenue without impairing their users' experience. Some Web site hosts have chosen to place advertising revenues over the interests of users. One such Web site is “Overture.com”, which hosts a so-called “search engine” service returning advertisements masquerading as “search results” in response to user queries. The Overture.com web site permits advertisers to pay to position an ad for their Web site (or a target Web site) higher up on the list of purported search results. If such schemes where the advertiser only pays if a user clicks on the ad (i.e., cost-per-click) are implemented, the advertiser lacks incentive to target their ads effectively, since a poorly targeted ad will not be clicked and therefore will not require payment. Consequently, high cost-per-click ads show up near or at the top, but do not necessarily translate into real revenue for the ad publisher because viewers don't click on them. Furthermore, ads that viewers would click on are further down the list, or not on the list at all, and so relevancy of ads is compromised.

Search engines, such as Google for example, have enabled advertisers to target their ads so that they will be rendered in conjunction with a search results page responsive to a query that is relevant, presumably, to the ad. Although search result pages afford advertisers a great opportunity to target their ads to a more receptive audience, search result pages are merely a fraction of page views of the World Wide Web, and yet a smaller fraction of advertising opportunities.

Thus, it would be useful to allow advertisers to put targeted ads on, or to serve ads in association with, any content perceived by people.

### § 2. SUMMARY OF THE INVENTION

The present invention allows advertisers to put targeted ads on, or to serve ads in association with, e-mail. The present invention may do so by (i) obtaining information associated with e-mail (“e-mail information”) that includes available spots for ads, and (ii) determining one or more ads relevant to the e-mail information. The determined ad or ads may then be combined with, or otherwise served in association with, the e-mail. Alternatively, the determined ad or ads could be provided to parties to an e-mail (e.g., sender, recipient) later.

In another embodiment, the present invention allows advertisers to put targeted ads on, or to serve ads in association with any document based on structured information. The present invention may do so by (i) obtaining structured data information associated with the document that includes available spots for ads, and (ii) determining one or more relevant ads. The determined ad or ads may then be combined with, or otherwise served in association with, the document. Alternatively, the determined ad or ads could be provided later.

### § 3. BRIEF DESCRIPTION OF THE DRAWINGS

FIG. 1 is a high-level diagram showing parties or entities that can interact with an advertising system.

FIG. 2 is a bubble chart of an exemplary advertising environment in which, or with which, the present invention may operate.

FIG. 3 illustrates an environment in which advertisers can target their ads on search results pages generated by a search engine, documents served by content servers, and/or e-mail.

FIG. 4 illustrates the use of internal e-mail information and/or external e-mail information to select ads in a manner consistent with the present invention.

FIG. 5 is a flow diagram of an exemplary method that may be used to select one or more ads using, at least, e-mail information and ad information in a manner consistent with the present invention.

FIG. 6 is a bubble diagram of operations that may be performed, and information that may be generated, used, and/or stored, in a manner consistent with the present invention.

FIG. 7 is a high-level block diagram of apparatus that may be used to perform at least some of the various operations that may be used and store at least some of the information that may be used and/or generated consistent with the present invention.

FIGS. 8-11 are messaging diagrams illustrating alternative ways to obtain e-mail information used to select one or more ads and to provide the e-mail with one or more ads.

### § 4. DETAILED DESCRIPTION

The present invention may involve novel methods, apparatus, message formats and/or data structures for allowing advertisers to put targeted, e-mail relevant ads on e-mail, or to serve such ads in association with e-mail. The following description is presented to enable one skilled in the art to make and use the invention, and is provided in the context of particular applications and their requirements. Various modifications to the disclosed embodiments will be apparent to those skilled in the art, and the general principles set forth below may be applied to other embodiments and applications. Thus, the present invention is not intended to be limited to the embodiments shown and the inventors regard their invention as any patentable subject matter described.

In the following, environments in which, or with which, the present invention may operate are described in § 4.1. Then, exemplary embodiments of the present invention are described in § 4.2. Examples of operations are provided in § 4.3. Finally, some conclusions regarding the present invention are set forth in § 4.4.

§ 4.1 Environments in which, or with which, the Present Invention May Operate

§ 4.1.1 Exemplary Advertising Environment

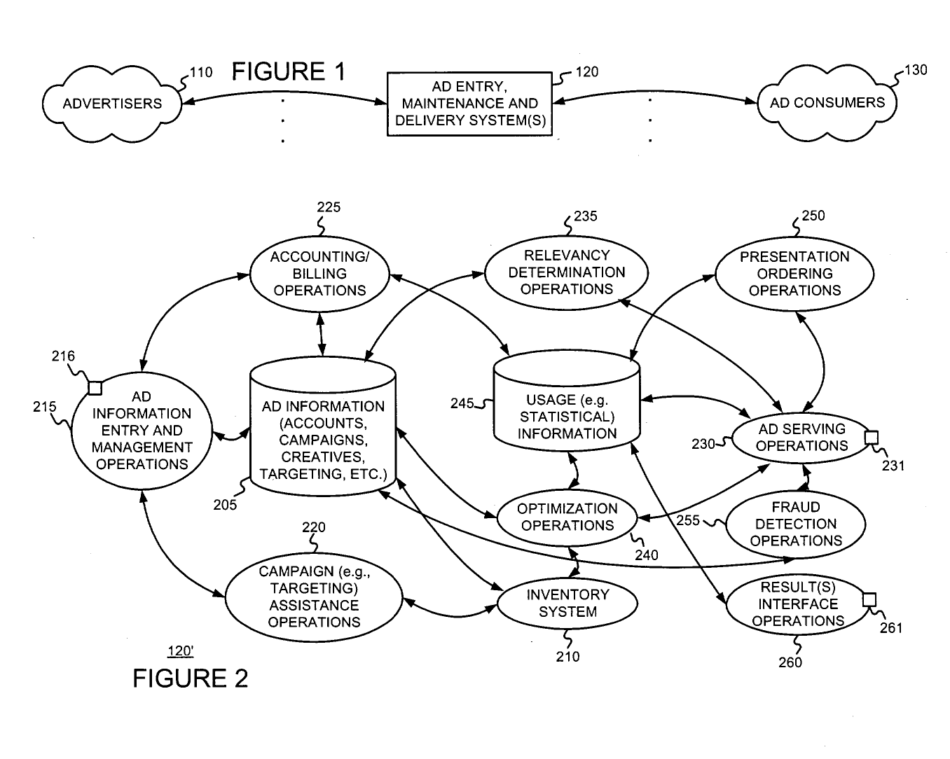

FIG. 1 is a high level diagram of an advertising environment. The environment may include an ad entry, maintenance and delivery system 120. Advertisers 110 may directly, or indirectly, enter, maintain, and track ad information in the system 120. The ads may be in the form of graphical ads such as so-called banner ads, text only ads, image ads, audio ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. An entity other than an ad consumer 130 may initiate a request for ads. Although not shown, other entities may provide usage information (e.g., whether or not a conversion or click-through related to the ad occurred) to the system 120. This usage information may include measured or observed user behavior related to ads that have been served.

One example of an ad consumer 130 is a general content server that receives requests for documents (e.g., articles, discussion threads, music, video, graphics, search results, Web page listings, etc.), and retrieves the requested document in response to, or otherwise services, the request. The content server may submit a request for ads to the system 120. Such an ad request may include a number of ads desired. The ad request may also include document request information. This information may include the document itself (e.g., page), a category corresponding to the content of the document or the document request (e.g., arts, business, computers, arts-movies, arts-music, etc.), part or all of the document request, content age, content type (e.g., text, graphics, video, audio, mixed media, etc.), geolocation information, etc.

The content server may combine the requested document with one or more of the advertisements provided by the system 120. This combined information including the document content and advertisement(s) is then forwarded towards the end user that requested the document, for presentation to the user. Finally, the content server may transmit information about the ads and how, when, and/or where the ads are to be rendered (e.g., position, click-through or not, impression time, impression date, size, conversion or not, etc.) back to the system 120. Alternatively, or in addition, such information may be provided back to the system 120 by some other means.

Another example of an ad consumer 130 is a search engine. A search engine may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine may submit a request for ads to the system 120. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, feature vectors of identified documents, etc.

The search engine may combine the search results with one or more of the advertisements provided by the system 120. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

Finally, the search engine may transmit information about the ad and when, where, and/or how the ad was to be rendered (e.g., position, click-through or not, impression time, impression date, size, conversion or not, etc.) back to the system 120. Alternatively, or in addition, such information may be provided back to the system 120 by some other means.

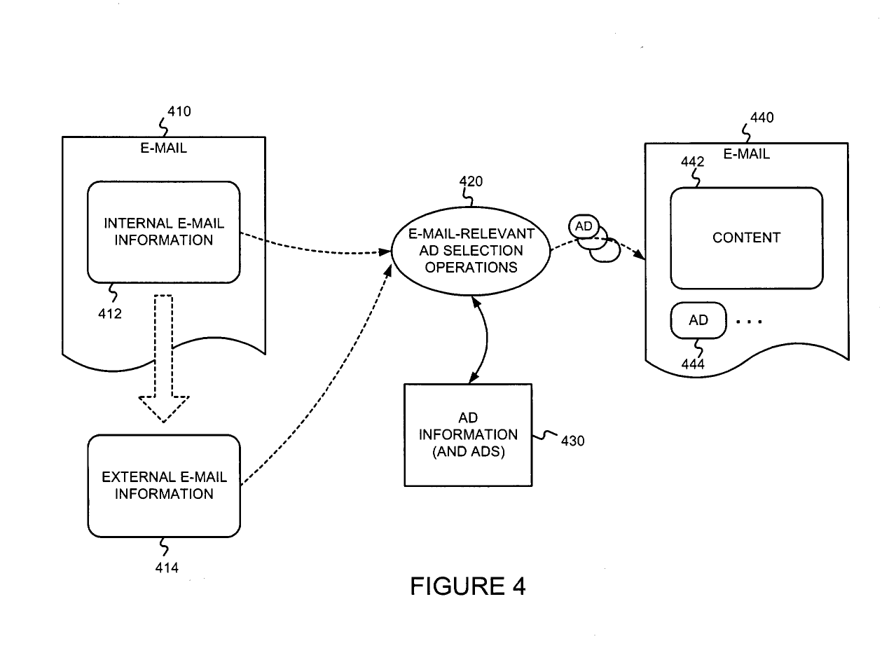

As can be appreciated from the foregoing, an ad entry, maintenance and delivery system(s) 120 may serve ad consumers 130 such as content servers and search engines. As discussed in § 1.2 above, the serving of ads targeted to the search results page generated by a search engine is known. As discussed in U.S. patent application Ser. No. U.S. patent application Ser. No. 10/375,900, entitled “SERVING ADVERTISEMENTS BASED ON CONTENT”, filed on Feb. 26, 2003 and listing Darrell Anderson, Paul Bucheit, Alex Carobus, Claire Cui, Jeffrey A. Dean, Georges R. Harik, Deepak Jindal and Narayanan Shivakumar as inventors, ads targeted to documents served by content servers may also be served. For example, referring to the exemplary environment of FIG. 3, a network or inter-network 360 may include an ad server 320 serving targeted ads in response to requests from a search engine 332 with ad spots for sale. Suppose that the inter-network 350 is the Web. The search engine 332 crawls much or all of the content 350. Some 334 of this content 350 will include ad spots (also referred to as “inventory”) available. More specifically, one or more content servers 336 may include one or more documents 340. Even if the document does not include explicitly defined available ad spots, it may be determined that ads can be served in, or in association with (e.g., in a window in the foreground above the document (referred to as a “pop-up window”), in the background under the document (referred to as a “pop-under window”), etc.) the document. The ad may partly or totally obscure the document, share the screen space with the document, take screen space from the document, be partly or totally obscured by the document, etc.

Still referring to FIG. 3, an e-mail server 392 (such as Microsoft Network (MSN) HotMail, Yahoo Mail, etc., for example) may be thought of, generally, as a content server in which a document served is simply an e-mail 390a. Further, e-mail applications 394 (such as Microsoft Outlook for example) may be used to send and/or receive e-mail 390b. Therefore, referring to both FIGS. 1 and 3, an e-mail server 392 or application 394 may be thought of as an ad consumer 130. Consistent with the present invention, e-mails 390 may be thought of as documents, and targeted ads may be served in association with such documents. For example, one or more ads may be served in, under over, or otherwise in association with an e-mail. Although some e-mail servers, such as Yahoo Mail for example, serve ads in e-mails, these ads are not targeted and therefore will not perform as well (e.g., in terms of user selection) as targeted ads.

§ 4.1.2 Exemplary Ad Entry, Maintenance and Delivery Environment

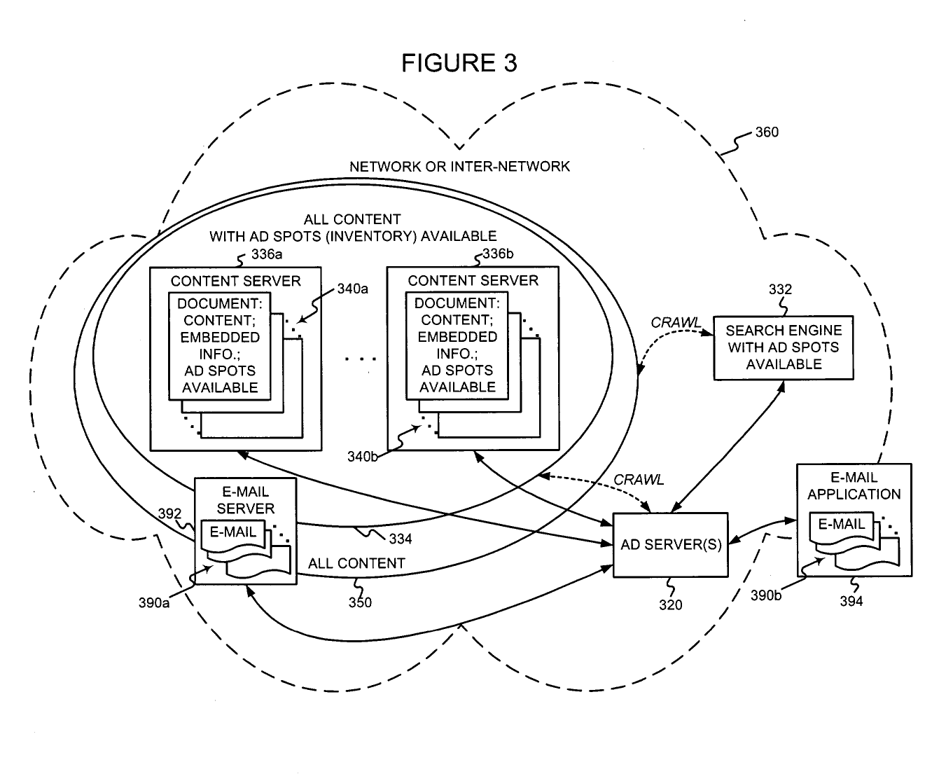

FIG. 2 illustrates an exemplary ad system 120′ with which the present invention may be used. The exemplary ad system 120′ may include an inventory system 210 and may store ad information 205 and usage information 245. The exemplary system 120′ may support ad information entry and management operations 215, campaign (e.g., targeting) assistance operations 220, accounting and billing operations 225, ad serving operations 230, relevancy determination operations 235, optimization operations 240, relative presentation attribute assignment (e.g., position ordering) operations 250, fraud detection operations 255, and result interface operations 260.

Advertisers 110 may interface with the system 120′ via the ad information entry and management operations 215 as indicated by interface 216. Ad consumers 130 may interface with the system 120′ via the ad serving operations 230 as indicated by interface 231. Ad consumers 130 and/or other entities (not shown) may also interface with the system 120′ via results interface operations 260 as indicated by interface 261.

An advertising program may include information concerning accounts, campaigns, creatives, targeting, etc. The term “account” relates to information for a given advertiser (e.g., a unique e-mail address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line have one or more ad groups, each containing one or more ads. Each ad group may include a set of keywords, and a maximum cost (cost per click-though, cost per conversion, etc.). Alternatively, or in addition, each ad group may include an average cost (e.g., average cost per click-through, average cost per conversion, etc.). Therefore, a single maximum cost and/or a single average cost may be associated with one or more keywords. As stated, each ad group may have one or more ads or “creatives” (That is, ad content that is ultimately rendered to an end user.). Naturally, the ad information 205 may include more or less information, and may be organized in a number of different ways.

The ad information 205 can be entered and managed via the ad information entry and management operations 215. Campaign (e.g., targeting) assistance operations 220 can be employed to help advertisers 110 generate effective ad campaigns. For example, the campaign assistance operations 220 can use information provided by the inventory system 210, which, in the context of advertising for use with a search engine, may track all possible ad impressions, ad impressions already reserved, and ad impressions available for given keywords. The ad serving operations 230 may service requests for ads from ad consumers 130. The ad serving operations 230 may use relevancy determination operations 235 to determine candidate ads for a given request. The ad serving operations 230 may then use optimization operations 240 to select a final set of one or more of the candidate ads. The ad serving operations 230 may then use relative presentation attribute assignment operations 250 to order the presentation of the ads to be returned. The accounting/billing operations 225 may be used to track charges related to the serving of advertisements and to bill advertisers. The fraud detection operations 255 can be used to reduce fraudulent use of the advertising system (e.g., by advertisers), such as through the use of stolen credit cards. Finally, the results interface operations 260 may be used to accept result information (from the ad consumers 130 or some other entity) about an ad actually served, such as whether or not click-through occurred, whether or not conversion occurred (e.g., whether the sale of an advertised item or service was initiated or consummated within a predetermined time from the rendering of the ad), etc. Such results information may be accepted at interface 261 and may include information to identify the ad and time the ad was served, as well as the associated result.

§ 4.1.3 Definitions

Online ads, such as those used in the exemplary systems described above with reference to FIGS. 1 and 2, or any other system, may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a page on which the ad was served, a search query or search results associated with the serving of the ad, a user characteristic (e.g., their geographic location, the language used by the user, the type of browser used, previous page views, previous behavior), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document being served includes certain topics or concepts, or falls under a particular cluster or clusters, or some other classification or classifications.

“Ad information” may include any combination of ad features, ad serving constraints, information derivable from ad features or ad serving constraints (referred to as “ad derived information”), and/or information related to the ad (referred to as “ad related information”), as well as an extensions of such information (e.g., information derived from ad related information).

A “document” is to be broadly interpreted to include any machine-readable and machine-storable work product. A document may be a file, a combination of files, one or more files with embedded links to other files, etc.; the files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as Javascript, etc.). In many cases, a document has a unique, addressable, storage location and can therefore be uniquely identified by this addressable location. A universal resource locator (URL) is a unique address used to access information on the Internet.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer or Netscape), a media player (e.g., an MP3 player, a Realnetworks streaming audio file player, etc.), a viewer (e.g., an Abobe Acrobat pdf reader), etc.

A “content owner” is a person or entity that has some property right in the content of a document. A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary.

“User information” may include user behavior information and/or user profile information, such as that described in U.S. patent application Ser. No. 10/______, entitled “SERVING ADVERTISEMENTS USING USER REQUEST INFORMATION AND USER INFORMATION,” filed on the same date as this application, and listing Krishna Bharat, Steve Lawrence, Mehran Sahami and Amit Singhal as inventors. This application is incorporated herein by reference.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

Various exemplary embodiments of the present invention are now described in § 4.2.

§ 4.2 Exemplary Embodiments

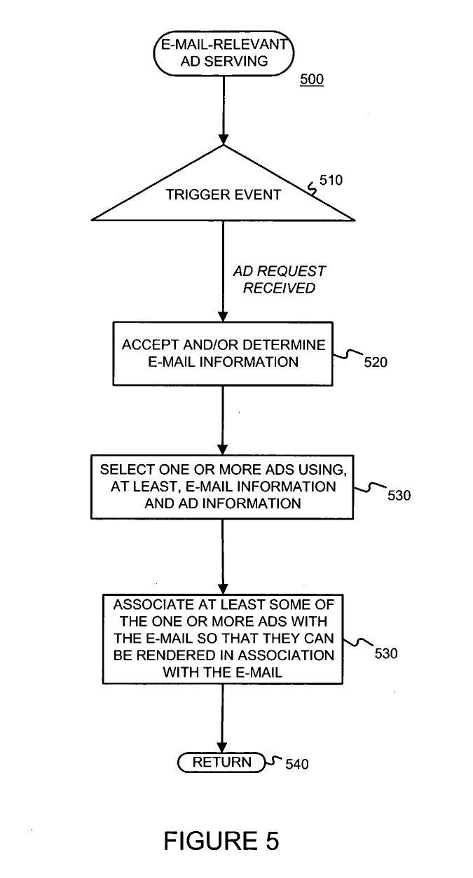

FIG. 4 illustrates using internal e-mail information and/or external e-mail information to select one or more ads in a manner consistent with the present invention. An e-mail document 410 may include internal e-mail information 412. In addition, the e-mail document 410 may be related to external e-mail information 414. The external information 414 may also, or alternatively, include e-mail derived information. E-mail relevant ad selection operations 420 may use e-mail information (e.g., 412 and/or 414) of the e-mail 410 and ad information 430 to select one or more ads from a set of ads 430. The selected one or more ads may be further refined, filtered, ordered, etc. by other operations (not shown). At a recipient e-mail application (such as Outlook from Microsoft for example), an instance 440 of the original e-mail 410 is provided. The instance 440 may include at least some internal e-mail information as content 442, such as a text body from the original e-mail 410, as well as one or more ads 444. Alternatively, or in addition, the one or more ads 444 could be rendered in association with (e.g., in a pop-up window, in a pop-under window, etc.) the e-mail 440.

The internal e-mail information 412 may include, for example, one or more of, or some combination of, the following:

information from a subject line;

information from body text,

a sender name and/or e-mail address;

one or more recipient names and/or e-mail addresses;

recipient type (e.g., direct recipient, cc recipient, bcc recipient, etc.);

text extracted from an e-mail address (people often include text about a favorite hobby or their profession in their e-mail addresses);

embedded information (e.g., a business card file, an image, a directory path or address, structured data (e.g., data indicating the meaning of associated content), etc.);

linked information (e.g., information from a Web page linked to from the e-mail); and

attached information (e.g., Word processor files, images, spreadsheets, etc.).

Other types of internal e-mail information 412 may be used in a manner consistent with the present invention.

The external e-mail information 414 may include, for example, one or more of, or some combination of, the following:

a topic or concept derived using text of the e-mail;

a topic or concept derived using an e-mail attachment,

a topic or concept derived using linked information;

information extracted or otherwise derived from search results returned in response to a search query composed of extracted e-mail information.

information about the sender (for example, derived from previous interactions with the sender);

information about a recipient (for example, derived from the sender (e.g. sender's address book entry or contact information for recipient, etc.); derived from interactions with the sender; or based on a profile or information about the sender who is sending a message to the recipient (e.g. sender is a wine enthusiast and has recently searched for and/or browsed on pages related to wine, suggesting that recipient may also be interested in wine); etc.;

information from other e-mails sent by the sender and/or received by the recipient;

information from other e-mails having the same or similar subject text;

information about a recipient from the sender's contact information;

information from the a common directory to embedded information (e.g., if an e-mail has an attached Word file, information from other files from the same directory (e.g., with the same directory path) as the attached Word file);

information from a common Website as a linked Web page;

a time the e-mail was sent (e.g. e-mails sent close to lunch time may include an advertisement for a local lunch establishment);

a geographic location of the e-mail sender; and

a geographic location of an e-mail recipient.

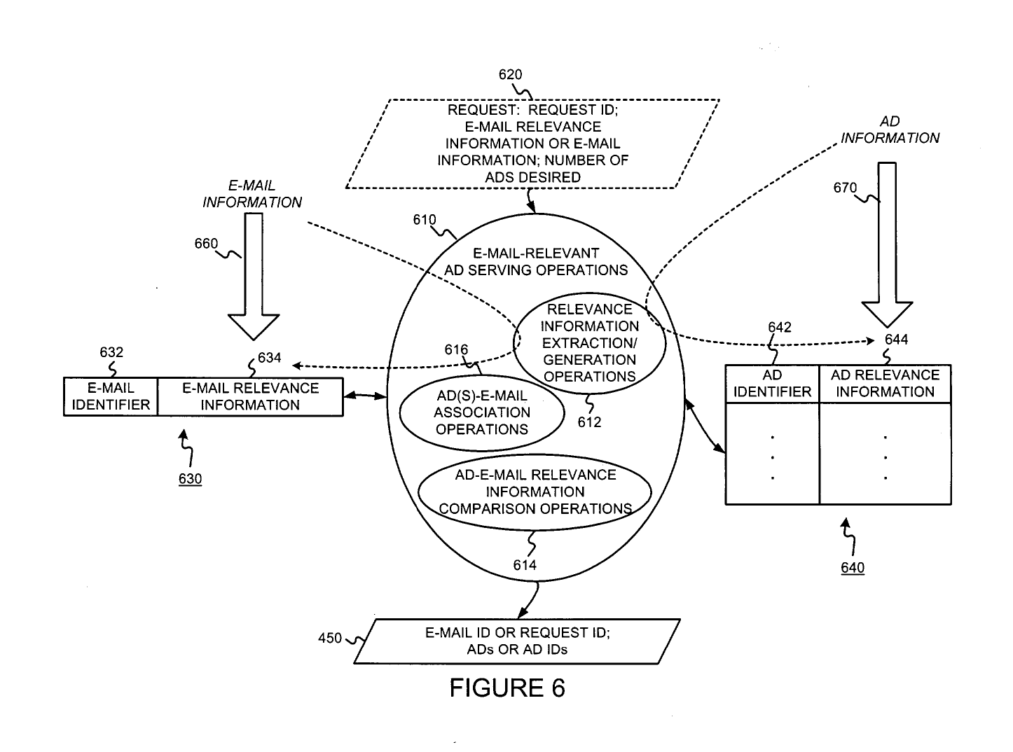

FIG. 5 is a flow diagram of an exemplary method 500 that may be used to select one or more ads using, at least, e-mail information and ad information, in a manner consistent with the present invention. The main portion of the method 500 may be triggered upon receipt of an ad request. (Trigger block 510) The ad request may include a number of ads desired and e-mail information for example. E-mail information is accepted and/or determined. (Block 520) Then, one or more ads are selected from a set of ads using, at least, some or all of the e-mail information and some or all of the ad information. (Block 530) At least some of the one or more ads may be associated with the e-mail so that they can be rendered in association with the e-mail (Block 540), before the method 500 is left (Node 550). This association of one or more ads with an e-mail may be performed by an ad server, an e-mail server, an e-mail sender, and/or an e-mail recipient.

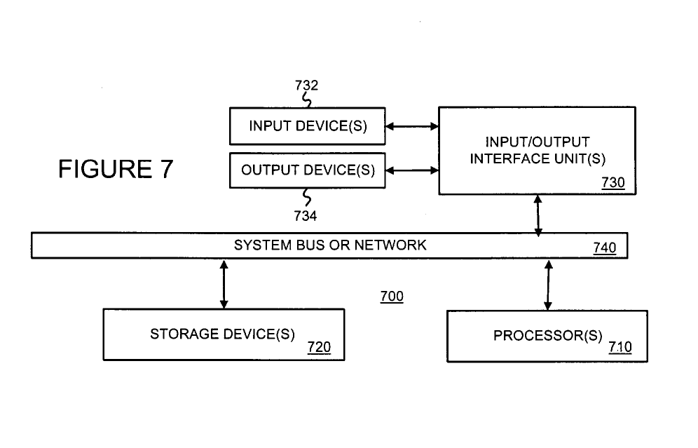

FIG. 6 is a bubble diagram of operations that may be performed and information that may be used or generated, in a manner consistent with the present invention. In the description of FIG. 6, e-mail and ad relevance information may be thought of as at least some e-mail and ad information put into a form (e.g., a topic, a concept, a cluster, a term vector, a feature vector, etc.) to permit comparisons. Preferably, these comparisons are convenient in terms of storage and/or processing resources.

E-mail relevant ad serving operations 610 may include relevance information extraction/generation operations 612, ad-e-mail relevance information comparison operations 614 and ad(s)-e-mail association operations 616. Responsive to a request 620, or some other trigger event or condition, the e-mail relevant ad serving operations 610 can extract and/or generate e-mail relevance information 634 and ad relevance information 644. (See operations 612.) Alternatively, or in addition, such relevance information may have been extracted and/or generated, or otherwise provided before receipt of the request 620 and/or provided in the request 620. That is, as indicated by the dotted arrows in FIG. 6, ad information and/or at least some e-mail relevance information (e.g., user information related to a sender) may be preprocessed to determine ad relevance information 644 and/or e-mail relevance information 634. Exemplary techniques for extracting and/or generating e-mail relevance information 634 and ad relevance information 644 are described in § 4.2.1 below. Then, the e-mail relevant ad serving operations 610 can compare e-mail relevance information 634 for a given e-mail 632 to ad relevance information 644 for one or more ads 642. (See operations 614.) Exemplary techniques for determining the relevance of ads to a document are described in § 4.2.2 below. As a result of such comparisons, the e-mail relevant ad serving operations 610 can generate associations of an e-mail (e.g., via an e-mail identifier or a request identifier associated with an e-mail) with one or more ads (e.g., via the ad itself or an ad identifier). (See operations 616.) One such association 650 is shown. Exemplary techniques for associating one or more ads with an e-mail are described in § 4.2.3 below.

The e-mail relevant ad serving operations 610 may also use stored data 640 which includes a number of entries, each entry including an ad identifier 642 and ad relevance information 644. As indicated by the arrow 670, ad relevance information 644 may be, or more have been, generated based on ad information.

Ultimately, one or more ads determined to be relevant to a document may be combined with the e-mail. Exemplary techniques for combining the one or more e-mail relevant ads with the e-mail are described below.

§ 4.2.1 Exemplary Techniques for Accepting/Determining E-Mail Information

Referring to block 520 of FIG. 5 and operations 612 of FIG. 6, in some embodiments of the invention, e-mail information extraction operations may be provided at the sender device and/or recipient device to extract information from the e-mail for purposes of targeting ads. Alternatively, an e-mail server may extract and/or generate e-mail information. Indeed, e-mail information extraction and/or generation may be distributed over more than one device (e.g., e-mail application, browser, e-mail server, e-mail information server, e-mail relevant ad server, etc.).

§ 4.2.2 Exemplary Techniques for Selecting One or More Ads Using E-Mail Information and Ad Information

Referring back to the exemplary embodiment of FIG. 6, e-mail relevant ad serving operations 610 may include relevance information extraction and/or generation operations 612. Various way of extracting and/or generating relevance information are described in U.S. Provisional Application Serial No. 60/413,536, entitled “METHODS AND APPARATUS FOR SERVING RELEVANT ADVERTISEMENTS”, filed on Sep. 24, 2002 and listing Jeffrey A. Dean, Georges R. Harik and Paul Bucheit as inventors, and in U.S. patent application Ser. No. 10/314,427, entitled “METHODS AND APPARATUS FOR SERVING RELEVANT ADVERTISEMENTS”, filed on Dec. 6, 2002 and listing Jeffrey A. Dean, Georges R. Harik and Paul Bucheit as inventors. Both of these applications are incorporated herein by reference. These applications are referred to collectively as “the relevant ad server applications”) Relevance information may be considered as a topic or cluster to which an ad or document (e.g., e-mail) belongs. U.S. Provisional Application Serial No. 60/416,144, entitled “Methods and Apparatus for Probabilistic Hierarchical Inferential Learner” filed on Oct. 3, 2002 (incorporated herein by reference) describes exemplary ways to determine one or more concepts or topics (referred to as “phil clusters”) of information that may be used consistent with the present invention.

In one exemplary embodiment of the present invention, off-line (perhaps nightly), a dump of a complete ads database is used to generate an index that maps topics (e.g., a phil cluster identifiers) to a set of matching ad groups. This may be done using one or more of (i) a set of serving constraints (targeting criteria) within the ad group, (ii) text of the ads within the ad group, (iii) content on the advertiser's Web site, etc.

The e-mail relevant ad serving operations 610 may also include ad-e-mail relevance information comparison operations 614 and association operations 616. Various similarity techniques, such as those described in the relevant ad server applications, may be used to determine a degree of similarity between an ad and an e-mail. Such similarly techniques may use the extracted and/or generated e-mail information and/or e-mail relevance information. One or more e-mail relevant ads may then be associated with an e-mail based on the similarity determinations. For example, an ad may be associated with an e-mail if its degree of similarity exceeds some absolute and/or relative threshold.

For example, e-mail information may be processed to generate relevance information, such as a cluster (e.g., a phil cluster), a topic, etc. The matching clusters may then be used as query terms in a large OR query to an index that maps topics (e.g., a phil cluster identifiers) to a set of matching ad groups. The results of this query may then be used as first cut set of candidate targeting criteria. The candidate ad groups may then be sent to the relevance information extraction and/or generation operations (e.g., a phil server) again to determine an actual information retrieval (IR) score for each ad group summarizing how well the criteria information plus the ad text itself matches the e-mail relevance information. Estimated or known performance parameters (e.g., click-through rates, conversion rates, etc.) for the ad group may be considered in helping determine the best scoring ad group.

Once a set of best ad groups have been selected, a final set of one or more ads may be selected using a list of criteria from the best ad group(s). The e-mail relevant an ad server can use this list to request that an ad be sent back if K of the M criteria sent match a single ad group. If so, the ad is provided to the requestor.

Performance information (e.g., a history of selections or conversions per URL or per domain) may be fed back in the system, so that e-mail clusters that tend to get better performance for particular kinds of ads (e.g., ads belonging to a particular cluster or topic) may be determined. This can be used to re-rank e-mail relevant ads such that the ads served are determined using some function of both e-mail-relevance and performance.

Depending on the type and form of e-mail information and ad information, various similarity techniques, heuristics, etc, may be used, exclusively or in concert, to match or associate one or more ads with an e-mail.

§ 4.2.3 Exemplary Techniques for Associating Selected One or More Ads with E-Mail

E-mail relevant ads can be combined with, or otherwise associated with, an associated e-mail by (a) the e-mail relevant ad server, (b) an e-mail service provider, (c) the sender's e-mail application, and/or (d) a recipient's e-mail application.

§ 4.2.4 Refinements

§ 4.2.4.1 Reporting to Advertisers

In one embodiment of the present invention, an advertiser may be provided with a summary including which of its ads were served. Performance measures (e.g., selections, conversions, impressions, etc.) may also be provided to the advertiser.

§ 4.2.4.2 Advertiser Control of Serving Ads

In one embodiment of the present invention, advertisers may have no control over where their ads shown—on an Web page, on the search results page generated by a search engine, in an e-mail, etc. In a refined embodiment of the present invention, advertisers can control how their ads are served. Such control may be effected by allowing the advertiser to opt-in, opt-out, manipulate bidding or budgeting controls, etc. For example, a binary opt-in/opt-out choice may be made by the advertiser, or inferred by the advertiser's inaction. Alternatively, advertisers can be provided with the ability to provide additional prices for each ad group that they would be willing to pay for “clicks on content-relevance-based targeted Web pages,” “clicks on content-relevance-based targeted e-mails,” etc. (which could be content-relevance-based ads, or ads on search pages that match the concept of their targeting criteria but not the actual keywords). In this alternative scheme, advertisers could completely opt out by bidding 0 for results (e.g., clicks, conversions, etc.).

§ 4.2.4.3 Filtering of Ads

In one embodiment of the invention, it may be desirable to control or filter the rendering of ads shown in conjunction with certain e-mails. For example, ad syndication partners may be provided some control over the ads shown in conjunction with their e-mails or e-mails that they serve. One simple way of providing such control would be to permit the syndication partners to use a blacklist of URLs for advertisers (e.g., competitors, disreputable firms, etc.), or terms of ads (e.g., inappropriate products, services, or terms), that should not be allowed.

§ 4.2.4.4 Imposing Serving Limits on Otherwise E-Mail Relevant Ads

In one exemplary embodiment of the present invention, showing the same ad to the same e-mail sender and/or recipient more than a predetermined number of times over a predetermined time period (e.g., once per day), or some similar heuristic is avoided. Otherwise, if a reply to an e-mail includes the earlier e-mail or threads of an earlier e-mail, the e-mails are likely to include overlapping information and, consequently, the users (senders/recipients) are likely to see the same ad repeatedly, which may hurt performance of the ad.

§ 4.2.4.5 Triggering E-Mail Relevant Ad Serving

Although some embodiments of the present invention will serve ads in an e-mail, or contemporaneously with an ad (e.g., in a pop-up window or pop-under window), e-mail relevant ads may be served later. Indeed, one or more e-mail relevant ads might be provided to the sender and/or a recipient in a separate e-mail (or multiple separate e-mails) or via some other means. This enables ads to be served to the sender of the e-mail.

§ 4.2.4.6 Ad Revenue Sharing and Other Forms of Compensation

In one embodiment of the present invention, ad revenue paid by an advertiser to an e-mail relevant ad server may be shared with one or more of (a) an e-mail sender who sends the e-mail with which ads are served, (b) an e-mail server who supports an e-mail sender and/or an e-mail recipient, who serves the e-mail with which ads are served, and (c) an e-mail recipient who receives the e-mail with which ads are served. However, if an advertiser pays based on the performance of ads, it may be advantageous if any payment to an e-mail recipient were independent of whether or not the recipient selects the ad. Otherwise, a recipient might have a monetary incentive to select an ad that they are not particularly interested in. Alternatively, or in addition, one or more of the foregoing parties may be provided with other forms of compensation. These other forms of compensation may be determined independently of ad revenue.

§ 4.2.5 Exemplary Apparatus

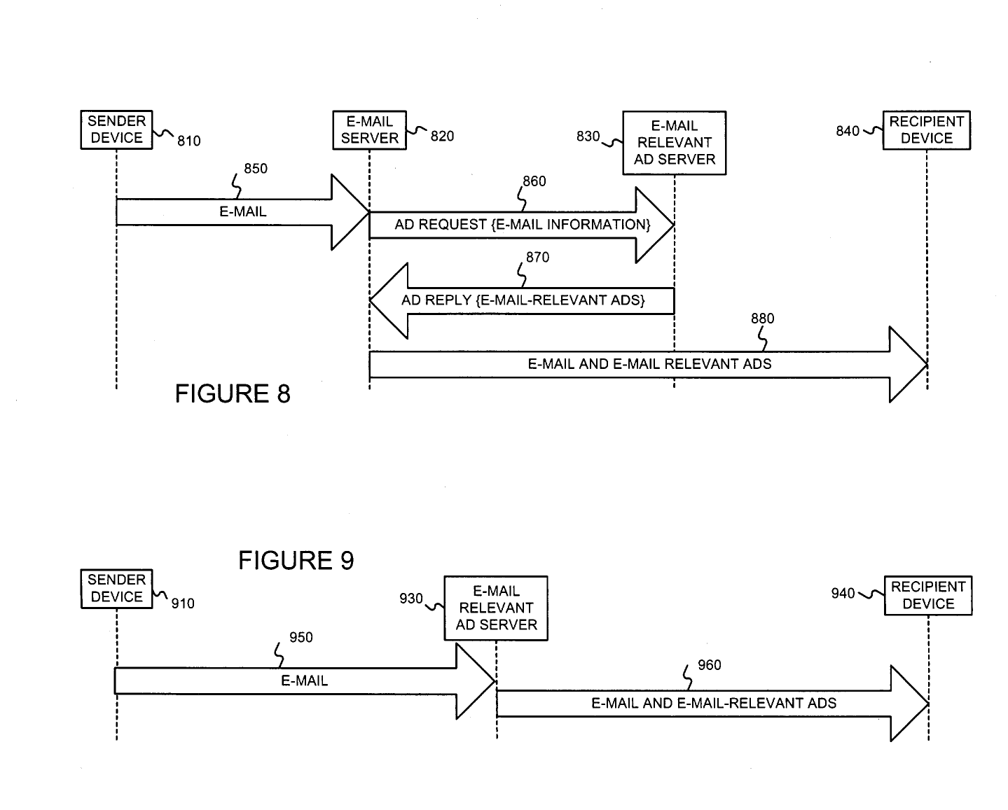

FIG. 7 is high-level block diagram of a machine 700 that may effect one or more of the operations discussed above. The machine 700 basically includes one or more processors 710, one or more input/output interface units 730, one or more storage devices 720, and one or more system buses and/or networks 740 for facilitating the communication of information among the coupled elements. One or more input devices 732 and one or more output devices 734 may be coupled with the one or more input/output interfaces 730.

The one or more processors 710 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to effect one or more aspects of the present invention. At least a portion of the machine executable instructions may be stored (temporarily or more permanently) on the one or more storage devices 720 and/or may be received from an external source via one or more input interface units 730.

In one embodiment, the machine 700 may be one or more conventional personal computers. In this case, the processing units 710 may be one or more microprocessors. The bus 740 may include a system bus. The storage devices 720 may include system memory, such as read only memory (ROM) and/or random access memory (RAM). The storage devices 720 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 732, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 710 through an appropriate interface 730 coupled to the system bus 740. The output devices 734 may include a monitor or other type of display device, which may also be connected to the system bus 740 via an appropriate interface. In addition to (or instead of) the monitor, the personal computer may include other (peripheral) output devices (not shown), such as speakers and printers for example.

Each of the sender device, recipient device, e-mail server, and e-mail relevant ad server may be one or more machines 700.

### § 4.3 EXAMPLES OF OPERATIONS

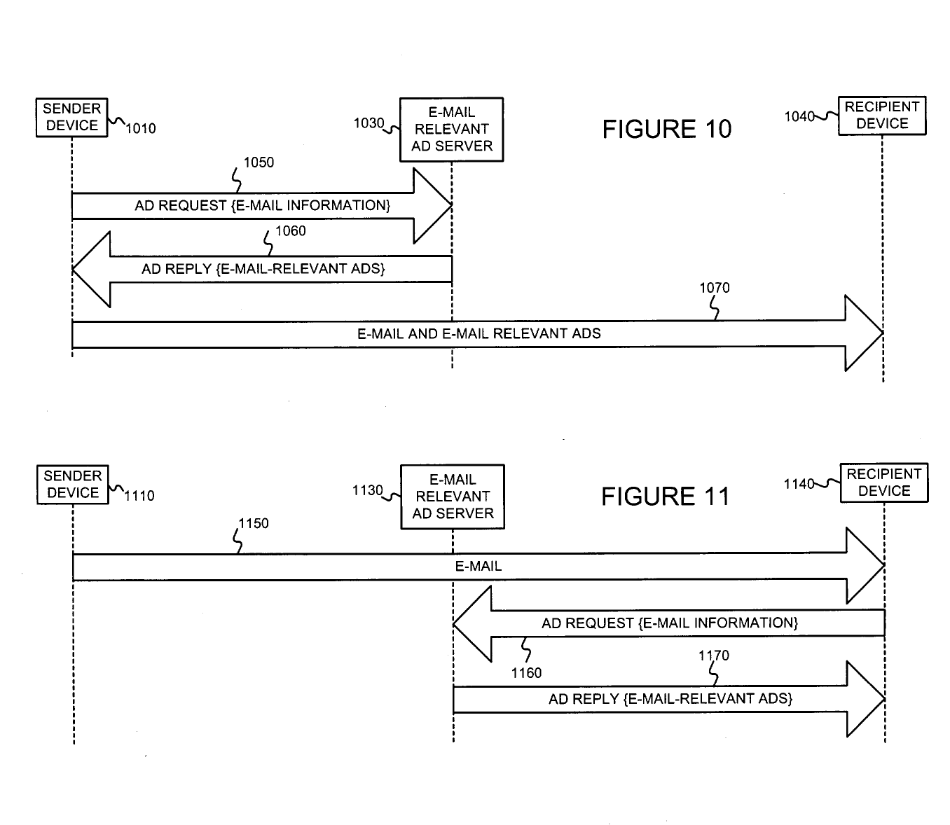

FIGS. 8-11 are messaging diagrams illustrating three alternative schemes for implementing the invention. In each of the schemes, a sender device 810,910,1010,1110 and a recipient device 840,940,1040,1140 may each be an e-mail application such as Microsoft Outlook for example, or a browser application such as Microsoft Explorer or Netscape Navigator effected on a personal computer for example, and the e-mail relevant ad server 830,930,1030,1130 may be one or more server computers on the Internet for example. In the scheme illustrated in FIG. 8, the e-mail server 820 may be an Internet-based, browser accessible e-mail server such as Hot Mail from Microsoft Network, or Yahoo Mail for example.

Referring to the scheme illustrated in FIG. 8, when a sender device 810 (e.g., a browser) submits an e-mail (communication 850) to an e-mail server 820, the e-mail server 820 can extract and/or generate e-mail information and submit an ad request (communication 860) to the e-mail relevant ad server 830. Using at least some of the e-mail information and ad information, the e-mail relevant ad server 830 may select one or more ads from a set of ads. The set of ads may be all available ads, or a previously filtered (e.g., based on price, performance, etc.) set of ads. Alternatively, or in addition, the selected one or more ads may be further reduced or filtered. In any event, the e-mail relevant ad server 830 may then return a reply including one or more ads (or pointers to such ads) (communication 870) to the e-mail ad server 820. The e-mail ad server may then combine or otherwise associate the one or more ads with the e-mail and send them (communication 880) to recipient device 840. At the recipient device 840, when the e-mail is rendered (e.g., displayed), it may include the one ore more ads, or one or more ads may be rendered in association with the e-mail. In this embodiment, the e-mail server 820 may execute special instructions to support the present invention. The e-mail server 820 may be used by the sender device 810, the recipient device 840, or both.

Referring to the scheme illustrated in FIG. 9, when a sender device 910 (e.g., Microsoft Outlook) is to send an e-mail, it does so via the e-mail relevant ad server 930. (Communication 950) The e-mail relevant ad server 930 extracts and/or generates e-mail information. It 930 then uses at least some of the e-mail information and ad information to select one or more ads. The e-mail relevant ad server 930 may then combine or otherwise associate the one or more ads with the e-mail and send them (Communication 960) to the recipient device 940. At the recipient device 940, when the e-mail is rendered (e.g., displayed), it may include the one or more ads, or the one or more ads may be rendered in association with the e-mail. In this embodiment, the sender device 910 may execute special instructions to support the present invention.

Referring to the scheme illustrated in FIG. 10, when a sender device 1010 (e.g., Microsoft Outlook) is to send an e-mail, it first submits an ad request, including at least some e-mail information (communication 1050), to an e-mail relevant ad server 1030. Using at least some of the e-mail information and ad information, the e-mail relevant ad server 1030 may select one or more ads from a set of ads. The set of ads may be all available ads, or a previously filtered (e.g., based on price, performance, etc.) set of ads. Alternatively, or in addition, the selected one or more ads may be further reduced or filtered. In any event, the e-mail relevant ad server 1030 may then return a reply including one or more ads (or pointers to such ads) (communication 1060) to the sender device 1010. The sender device 1010 may then combine or otherwise associate the one or more ads with the e-mail and send them (communication 1070) to recipient device 1040. At the recipient device 1040, when the e-mail is rendered (e.g., displayed), it may include the one ore more ads, or one or more ads may be rendered in association with the e-mail. In this embodiment, the sender device 1010 may execute special instructions to support the present invention.

Referring to the scheme illustrated in FIG. 11, a sender device 1110 (e.g., Microsoft Outlook) sends an e-mail (communication 1150) to the recipient device 1140. The recipient device 1140 can extract and/or generate e-mail information and submit an ad request (communication 1160) to the e-mail relevant ad server 1130. Using at least some of the e-mail information and ad information, the e-mail relevant ad server 1130 may select one or more ads from a set of ads. The set of ads may be all available ads, or a previously filtered (e.g., based on price, performance, etc.) set of ads. Alternatively, or in addition, the selected one or more ads may be further reduced or filtered. In any event, the e-mail relevant ad server 1130 may then return a reply including one or more ads (or pointers to such ads) (communication 1170) to the recipient device 1140. At the recipient device 1140, when the e-mail is rendered (e.g., displayed), it may include the one ore more ads, or one or more ads may be rendered in association with the e-mail. In this embodiment, the recipient device 1140 may execute special instructions to support the present invention.

### § 4.4 CONCLUSIONS

As can be appreciated from the foregoing disclosure, the invention can be used to expand situations in which targeted can be used. The inventors contemplate that one or more of the foregoing aspects or exemplary embodiments may be used in concert.

What is claimed is:

1. A method comprising:
a) accepting ad information associated with a first set of ads;
b) accepting e-mail information of an e-mail;
c) selecting one or more ads from the first set of ads using, at least, the accepted ad information and the accepted e-mail information.

2. The method of claim 1 further comprising providing in association with the e-mail, at least some of the one or more ads selected.

3. The method of claim 2 wherein the at least some of the one or more ads selected are provided in association with the e-mail by inserting them into the e-mail.

4. The method of claim 2 wherein the at least some of the one or more ads selected are provided in association with the e-mail by providing them in a window associated with the e-mail.

5. The method of claim 1 wherein the e-mail information accepted is exclusively internal e-mail information.

6. The method of claim 5 wherein the internal e-mail information includes at least one of (A) a sender name, (B) a sender e-mail address, (C) a recipient name, (D) a recipient e-mail address, (E) a CC recipient name, (F) a CC recipient e-mail address, (G) a BCC recipient name, (H) a BCC recipient e-mail address, (I) at least a part of text from a subject line, (J) at least a part of text from a body of the e-mail, (K) information embedded in the e-mail, and (L) link information in the e-mail.

7. The method of claim 1 wherein the e-mail information accepted is exclusively external e-mail information.

8. The method of claim 7 wherein the external e-mail information includes at least one of (A) user information about a sender, (B) user information about a recipient, (C) user information about a CC recipient, (D) user information about a BCC recipient, (E) information from a document linked to from the e-mail, and (F) information extracted from search results returned from a search using terms extracted from an e-mail.

9. The method of claim 1 wherein the e-mail information accepted includes both internal e-mail information and external e-mail information.

10. The method of claim 1, wherein the accepted ad information includes, for each of the ads in the first set of ads, at least one ad topic, and
wherein the act of selecting one or more ads from the first set of ads using, at least, the accepted ad information and the accepted e-mail information includes,
i) determining at least one e-mail topic from the accepted e-mail information,
ii) comparing the determined at least one e-mail topic with each of the at least one ad topics for each of the ads of the first set to generate comparisons, and
iii) selecting one or more ads using the comparisons.

11. The method of claim 1 wherein at least some of the e-mail information is accepted from a sender device.

12. The method of claim 1 wherein at least some of the e-mail information is accepted from a recipient device.

13. The method of claim 1 wherein at least some of the e-mail information is accepted from an e-mail server.

14. The method of claim 13 wherein the e-mail server is a Web-based e-mail server.

15. The method of claim 1 wherein at least some of the e-mail information is accepted from both a sender device and an e-mail server.

16. The method of claim 1 wherein at least some of the e-mail information is accepted from both a recipient device and an e-mail server.

17. The method of claim 1 wherein at least some of the e-mail information is accepted from both a sender device and a recipient device.

18. The method of claim 1 wherein at least some of the e-mail information is accepted from an information server.

19. A machine-readable storage device having stored thereon machine-readable information including:
i) an e-mail; and
ii) at least one e-mail relevant ad.

20. Apparatus comprising:
a) an input for accepting
ad information associated with a first set of ads, and
e-mail information of an e-mail; and
b) means for selecting one or more ads from the first set of ads using, at least, the accepted ad information and the accepted e-mail information.

21. The apparatus of claim 20 further comprising means for associating at least some of the one or more ads selected with the e-mail.

22. The apparatus of claim 21 wherein the means for associating inserts the ads into the e-mail.

23. The apparatus of claim 21 wherein the means for associating provides the at least some of the one or more ads selected in a window associated with the e-mail.

24. The apparatus of claim 20 wherein the e-mail information accepted is exclusively internal e-mail information.

25. The apparatus of claim 24 wherein the internal e-mail information includes at least one of (A) a sender name, (B) a sender e-mail address, (C) a recipient name, (D) a recipient e-mail address, (E) a CC recipient name, (F) a CC recipient e-mail address, (G) a BCC recipient name, (H) a BCC recipient e-mail address, (I) at least a part of text from a subject line, (J) at least a part of text from a body of the e-mail, (K) information embedded in the e-mail, and (L) link information in the e-mail.

26. The apparatus of claim 20 wherein the e-mail information accepted is exclusively external e-mail information.

27. The apparatus of claim 26 wherein the external e-mail information includes at least one of (A) user information about a sender, (B) user information about a recipient, (C) user information about a CC recipient, (D) user information about a BCC recipient, (E) information from a document linked to from the e-mail, and (F) information extracted from search results returned from a search using terms extracted from an e-mail.

28. The apparatus of claim 20 wherein the e-mail information accepted includes both internal e-mail information and external e-mail information.

29. The apparatus of claim 20, wherein the accepted ad information includes, for each of the ads in the first set of ads, at least one ad topic, and
wherein the means for selecting one or more ads from the first set of ads using, at least, the accepted ad information and the accepted e-mail information includes,
i) means for determining at least one e-mail topic from the accepted e-mail information,
ii) means for comparing the determined at least one e-mail topic with each of the at least one ad topics for each of the ads of the first set to generate comparisons, and
iii) means for selecting one or more ads using the comparisons.

30. The apparatus of claim 20 wherein at least some of the e-mail information is accepted from a sender device.

31. The apparatus of claim 20 wherein at least some of the e-mail information is accepted from a recipient device.

32. The apparatus of claim 20 wherein at least some of the e-mail information is accepted from an e-mail server.

33. The apparatus of claim 32 wherein the e-mail server is an Internet-based e-mail server.

34. The apparatus of claim 20 wherein at least some of the e-mail information is accepted from both a sender device and an e-mail server.

35. The apparatus of claim 20 wherein at least some of the e-mail information is accepted from both a recipient device and an e-mail server.

36. The apparatus of claim 20 wherein at least some of the e-mail information is accepted from both a sender device and a recipient device.

37. The apparatus of claim 20 wherein at least some of the e-mail information is accepted from an information server.

38. A method comprising:
a) accepting ad information associated with a first set of ads;
b) accepting structured data information of a document;
c) selecting one or more ads from the first set of ads using, at least, the accepted ad information and the accepted structured data information.

39. The method of claim 38 further comprising providing in association with the document, at least some of the one or more ads selected.

40. The method of claim 39 wherein the at least some of the one or more ads selected are provided in association with the document by inserting them into the document.

41. The method of claim 39 wherein the at least some of the one or more ads selected are provided in association with the document by providing them in a window associated with the document.

42. The method of claim 38 wherein structured data information is information that indicates a meaning of associated content.

43. The method of claim 42 wherein structured data information is an e-mail field.

44. The method of claim 42 wherein structured data information is an HTML tag.

45. Apparatus comprising:
a) an input for accepting
ad information associated with a first set of ads, and
structured data information of a document; and
b) means for selecting one or more ads from the first set of ads using, at least, the accepted ad information and the accepted structured data information.

46. The apparatus of claim 45 further comprising means for providing, in association with the document, at least some of the one or more ads selected.

47. The apparatus of claim 46 wherein means for providing provides the at least some of the one or more ads selected, in association with the document, by inserting them into the document.

48. The apparatus of claim 46 wherein the means for providing provides at least some of the one or more ads selected, in association with the document, by providing them in a window associated with the document.

49. The apparatus of claim 45 wherein structured data information is information that indicates a meaning of associated content.

50. The apparatus of claim 49 wherein structured data information is an e-mail field.

51. The method of claim 49 wherein structured data information is an HTML tag.
